(19) United States
(12) Patent Application Publication
(10) Pub. No.: US 2025/0320438 A1
(43) Pub. Date: Oct. 16, 2025

(54) Wet Etch Formulations for Semiconductor Processing

(71) Applicant: M-R Advanced Technologies, LLC, Hillsboro, OR (US)

(72) Inventor: Shankar B Rananavare, Hillsboro, OR (US)

(73) Assignee: M-R Advanced Technologies, LLC, Hillsboro, OR (US)

(21) Appl. No.: 18/990,553

(22) Filed: Dec. 20, 2024

Related U.S. Application Data
(60) Provisional application No. 63/632,330, filed on Apr. 10, 2024.

(51) Int. Cl. C11D 7/32; C11D 7/06

(52) U.S. Cl. CPC C11D 7/3209; C11D 7/06; C11D 2111/22

(57) ABSTRACT

Wet etch formulations and techniques for selectively removing a metallic hard-mask layer and post plasma etch residue/polymer addressing both the back end and front end of the line semiconductor processing applications are disclosed. In some embodiments, titanium (Ti) or titanium nitride (TiN) hard-mask layer and post-plasma etch residue/polymer is removed. These formulations can selectively remove metallic hard-masks comprising Ti and/or TiN while exhibiting near infinite compatibility towards exposed and underlying materials such as inner layer dielectric, insulating materials, oxides, and other metals. Three key applications are disclosed: Ti/TiN hard-mask and post plasma etch residue/polymer are removed while Cu, W, or Al are exposed to the wet etch formulation. The wet etch cleaning solution comprises fluorine-based components such as ammonium fluoride and hydrofluoric acid, organic bases such as tetramethylammonium hydroxide, inorganic bases and salts such as potassium hydroxide and potassium fluoride, hydrogen peroxide, hydrogen peroxide stabilizers, and a mixture of organic corrosion inhibitors.

### CROSS REFERENCE TO RELATED APPLICATIONS

This application claims priority to co-pending U.S. Provisional Application, Ser. No. 63/632,330, filed on Apr. 10, 2024, which is hereby incorporated by reference for all purposes.

### BACKGROUND

Embodiments of the present invention relate to the fabrication of an integrated circuit (IC) structure. More particularly, embodiments of the present invention pertain to selective wet etching, a metal hard-masks employed to assist in dual damascene patterning of Cu interconnects. Furthermore, a liquid formulation removes organic and inorganic byproducts from the dry/plasma etch. The introduction of metallic hard masks to build advanced semiconductor devices mandated the creation of unique wet etch chemical formulations and processes capable of removing the material as mentioned above while maintaining exceptional compatibility towards exposed and underlying materials such as interlayer dielectrics (ILD), insulating materials, oxides, tungsten, copper, and aluminum.

The manufacturing of semiconductor devices often involves forming integrated circuits on a microelectronic substrate, such as a silicon wafer. These ICs may include transistors, diodes, resistors, capacitors, combinations thereof, and the like, which may be connected via a metal network (metal interconnect systems). Various processes are known for forming metal networks on a microelectronic substrate. Among those processes is the so-called “damascene process,” which typically involves using lithography and etching to selectively remove material to form desired patterns, such as vias or trenches on a substrate or other dielectric material. Non-limiting examples of lithography include extreme UV (a type of X-ray where reflective masks are used). It may also include E-beam lithography, where charged particles, as opposed to electromagnetic radiation, are employed to create lithographic patterns.

In photolithography, a light-sensitive photoresist emulsion material is coated and patterned by UV light exposure through a mask bearing the desired circuit pattern. After lithography, the patterned photoresist film selectively exposes the underlying substrate (patterning) that can be etched by plasma or wet etch chemistries. In contrast, the remaining photoresist film protects the unexposed region. After etching, the photoresist may be removed (e.g., using an oxygen plasma or selective wet etching), and the openings filled with a conductive material such as a metal or metal alloy, e.g., via physical vapor deposition, chemical vapor deposition, electroplating, or some other mechanism.

Over the last seventy years, the size of microelectronic devices has shrunk substantially, yet their complexity has increased. As a result, it is becoming increasingly difficult to form suitable patterns using conventional masking materials and wet etch chemistry. Using titanium or its compounds (e.g., TiN) as a hard mask has become commonplace in fabricating copper interconnects using the Dual Damascene (DD) process. Compared to silicon oxide/nitride or organic photoresist-based masks, the Titanium-based hard mask enabled the transition to lower critical dimensions due to their resistance to the plasma processing used in the DD process. The use of a sacrificial hard-mask allows control over via flare. Additional key benefits of hard masks are: 1) allows for a wide process window for etch rate control, which enhances etch selectivity; 2) permits for significant improvement in etching high aspect ratio structures with robust via and trench profiles; 3) critical dimension (CD) control which allows for acceptable etch bias (EB) of the critical dimension; 4) protects the ILD material, porous ILD in particular, from damage induced by the plasma during the dry etch process; and 5) acts as an interface between the ILD and photoresist during both the via and trench patterning steps. Introducing TiN hard-mask for the back end of line (BEOL) dual damascene patterning created a unique application that required developing robust selective wet etch chemical formulations and processes.

Additionally, titanium and titanium nitride as barrier layers or conductive layers are useful in the production of microelectronic devices. For example, a bilayer of titanium and titanium nitride may be used as a fill barrier during the production of gates and/or gate contacts in microelectronic transistors. With the foregoing in mind, layers of Ti and TiN are often deposited in such a manner that they are present on the surfaces they are intended to cover, as well as adjacent surfaces. Because titanium is conductive, its presence on such adjacent surfaces may cause problems, particularly if the layers create an electric pathway between multiple microelectronic devices or components. Indeed, the titanium may cause an electrical short circuit in such instances, preventing the associated microelectronic device from functioning properly. Technologies such as chemical mechanical polishing (CMP), high-density plasma etching, and hydrofluoric (HF) acid-based wet etching formulations have been developed to selectively remove titanium and titanium nitride. While such technologies are effective, their use often damages the surface of the device and/or structures that are near the target titanium and titanium nitride. For example, titanium and titanium nitride are frequently used near metals, oxides, insulating materials, dielectric materials, etc., any or all of which may be attacked by these approaches. Therefore, these technologies are unsuitable for etching Titanium and/or Titanium nitride in the presence of metals, oxides, and/or dielectric materials.

The DD process, which uses electroplating of copper in patterned interconnect structures, creates a complex surface containing various metals, insulators, and post-plasma etch residues. Post-etch residues contain metal, carbon, oxygen, and fluorine-containing polymers due to plasma processing used for pattern transfer. See FIG. 1. While post-etch residues and hard masks must be removed, the wet etch formulation must be selective in removing the target material and must not impact exposed dielectric, oxides, and metals (such as W and copper shown in FIG. 3 and FIG. 4) involved in fabricating the IC.

Wet etch formulations for Ti and or TiN hard-mask removal have been developed to meet these demands. Such a formulation must first oxidize Ti and or TiN and then form solvent (typically water) soluble species requiring strong oxidants, such as hydrogen peroxide or sulfuric acid. Water-soluble species such as titanium cations or titanate anions are known to form in low pH and high pH environments, respectively, according to the Pourbaix Diagram for Ti. Therefore, Ti etch formulations fall into two categories based on the formulation's low or high pH. However, such a corrosive environment is not desirable for selective wet formulations to maintain compatibility with exposed material.

These findings have led researchers to explore other water-soluble complex anions, such as TiF6⁻², by introducing fluoride-containing species in the formulations presented in this patent. The added benefit of these formulations containing fluoride ions is their ability to solubilize post-etch organic/polymeric residues. Essentially, the adsorption/binding of fluoride ions creates a low-energy interface between residues and the wafer surface, which aids in cleaning. However, fluoride-containing formulations with low pH may lead to HF formation capable of undesirable oxide etch. A prior art shows how the use of silanes allows suppression of the oxide etch rate at low pH. In general, control over pH during the etch process is realized, as shown later, by introducing additional components (acids/bases/complexing agents) for etching by a dedicated line to the etch chamber. This approach offers flexibility and tunability of pH when necessary. Such is the case for tungsten, which forms a protective oxide layer at low pH.

Another approach to realizing selective wet etch compatibility is introducing inhibitors that bind selectively to the surfaces, thereby suppressing their etching. Upon binding, inhibitors block access of formulation components to the surface. The molecular structure of inhibitors is critical; a strong binding group to the surface, the ability to form densely packed monolayers, and solubility in the formulation are the essential features. For example, high energy binding through nitrogen-containing functional groups and aromatic rings to pack densely on the surface are standard features in inhibitors used to protect copper. Note that TiN is significantly more stable and chemically resistant than Cu from a thermodynamics point of view, as supported by the galvanic series requiring protection during the hard-mask etching/residue cleaning process.

However, since the surface topology of the oxides or metals to be protected is far from atomically smooth, a combination of inhibitors works best. Because of the different exposed crystallographic planes, the surface packing of the inhibitors requires a suitable combination of inhibitors of different binding geometries to match the underlying atomic packing of the binding surface.

### SUMMARY

The invention is a composition for removing Ti and/or TiN hard masks, post-dry etch organic and inorganic residues, and polymers. The composition comprises high-molecular-weight organic bases, inorganic bases, fluoride components, sulfate and phosphate salts, organic corrosion inhibitors, and an oxidizer. It is combined with semiconductor-grade deionized water (UPW). The pH and oxidizer concentration are adjusted based on the conductive layer, such as copper, aluminum, or tungsten.

### BRIEF DESCRIPTION OF THE DRAWINGS

FIG. 1 shows the Ti or TiN layer and post-plasma etch residue/polymer that must be removed selectively while maintaining compatibility with exposed materials ILD, Oxide, etch-stop (ES), and W.

FIG. 2 illustrates the structure after the TiN/Ti wet etch.

FIG. 3 depicts a similar structure to FIG. 2, except that copper is exposed to the wet etch formulation.

FIG. 4 displays the interconnect system in which post-dry etch residue/polymer is applied over aluminum while protecting the aluminum. It also shows the front and Back End Of Line (FEOL and BEOL) layers on a typical IC.

FIG. 5 shows the before and after wet etching in the presence of tungsten.

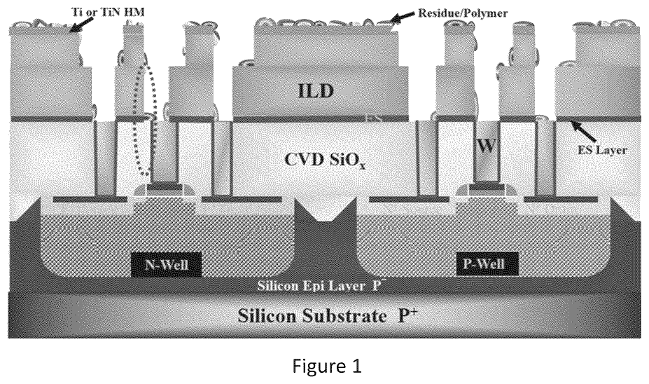

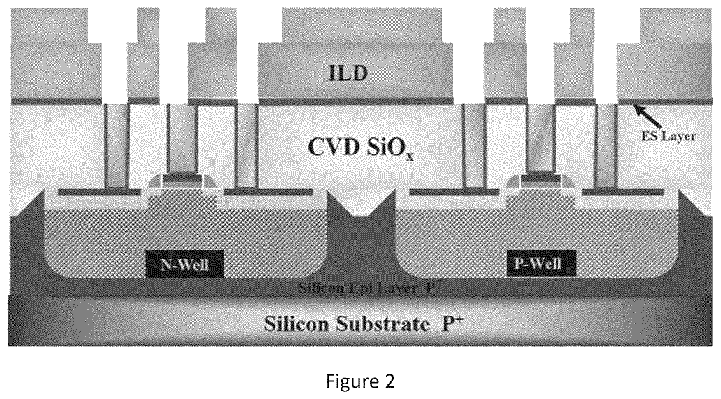

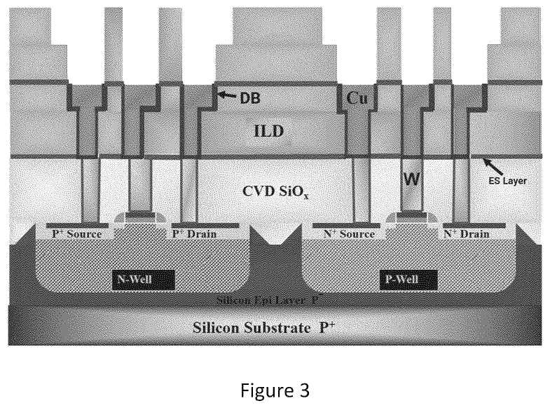

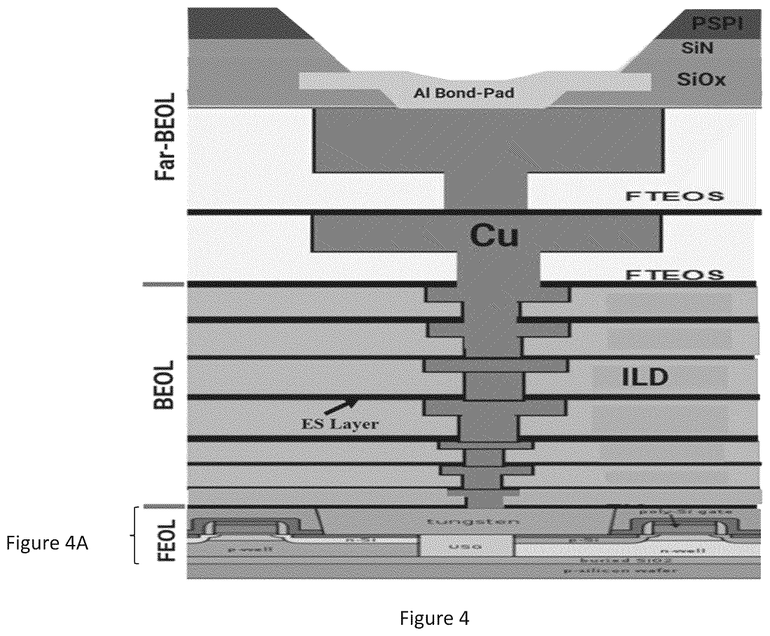

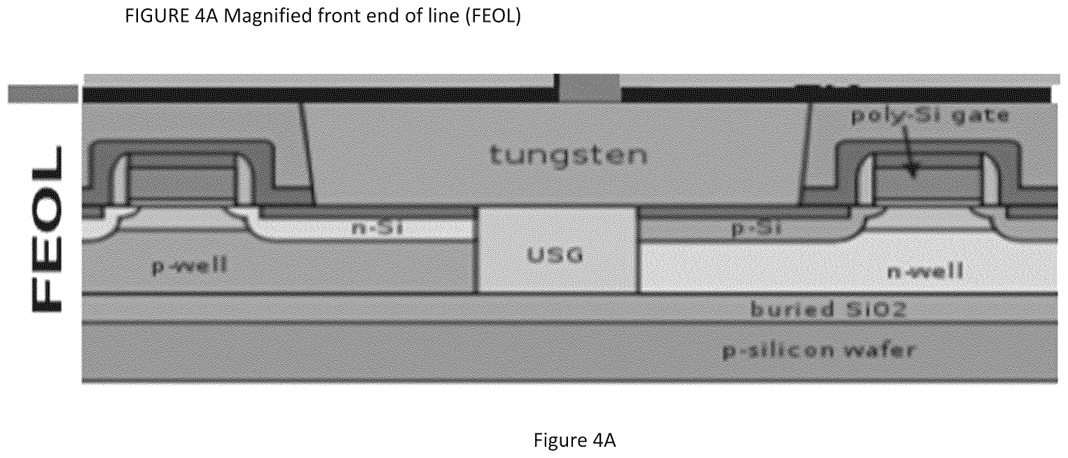

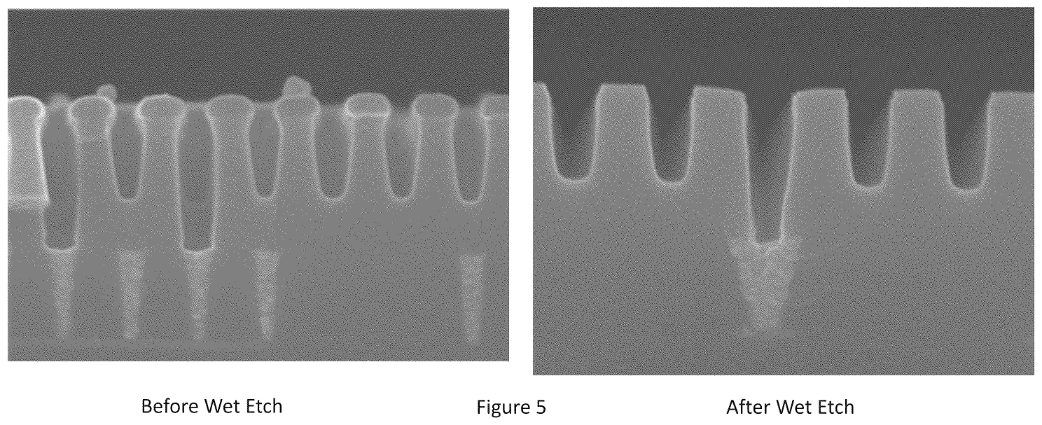

### DETAILED DESCRIPTION

The disclosed widgets will become better understood by reviewing the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various widgets are provided. Related features in the examples may be identical, similar, or dissimilar in different examples. For the sake of brevity, related features will not be redundantly explained in each example. Instead, using related feature names will cue the reader that the feature with a related name may be similar to the related feature in an example explained previously. Features specific to a given example will be described in that particular example. The reader should understand that a given feature need not be the same or similar to the specific portrayal of a related feature in any given figure or example.

### Wet Etch Formulations for Semiconductor Processing

With reference to the figures, WET ETCH FORMULATIONS FOR SEMICONDUCTOR PROCESSING will now be described. The invention disclosure herein discusses developing a unique TIN selective wet etch chemical formulation. The formulation is a chemical solution that exhibits unique selectivity characteristics that are compatible with interconnect fabrication requirements. The ability to etch a sacrificial TiN hard-mask layer without adversely impacting fundamental interconnect structures has been successfully demonstrated.

The wet etch formulation was developed to address the problem of selectively stripping thin, patterned TiN layer used as a hard mask along with post-dry etch residues/polymers from a substrate with superior compatibility towards Cu, silicon oxide, nitrogen-doped silicon oxide (SiON), silicon carbide, low-K, and porous ultra-low-K ILD film.

The new formulation/process significantly improves performance and cost over the current state of the art. The observed etch rates are increased, and selectivity is greatly enhanced. The process for this new chemical formulation has been optimized to operate over a wide temperature range, viz. 20-80° C. without adversely impacting key interconnect components during TiN removal. Current state-of-the-art chemistry/process performance is not as robust as it leads to significant Cu corrosion at temperatures above 50° C.

The formulation is composed of a mixture of reagents with unique characteristics. It contains a blend of organic bases, fluoride components, sulfate and phosphate salts, and organic Cu corrosion inhibitors. During wafer processing, the formulation is combined with UPW water and an oxidizer such as hydrogen peroxide H₂O₂. This new formulation is also environmentally friendly, containing more than 94% water. Therefore, it offers a significant reduction in waste management costs.

High molecular weight organic bases such as TMAH offer longer bath lifetimes when compared to low molecular weight bases such as NH₄OH. In addition to their lower vapor pressure, they also lower the formulation's surface tension, which is necessary to dislodge nano/micrometer scale residue particles by reducing the Laplace barriers for infiltration. The additional inorganic bases, such as KOH, raise the pH of the formulation efficiently, which eventually attains values of 7-8 when combined with the acidic oxidant H₂O₂. Given the high-temperature operation, peroxide undergoes significant thermal degradation, reducing bath life. Therefore, the formulation also contains various peroxide stabilizers that suppress the thermal decomposition of H₂O₂, leading to significant operational cost savings. A lower decomposition rate means one may use lower peroxide concentration and a higher operational temperature where etch rates are faster (see Table 2, below), resulting in further cost and time savings. It has also been demonstrated that the amount of oxidizer (H₂O₂) mixed with the new formulation can be reduced by up to 50% without any issues with TiN removal performance.

In addition, the formulation contains a significant concentration of fluoride species not only to etch Ti species on the surface but, as discussed before, to improve the cleanability of the wafer. Although the exact mechanism of the cleanability is unknown, fluoride adsorption would create lower energy surfaces on residue particles that can be easily dislodged. Another possibility is a cleavage of organometallic polymer containing Ti in its backbone. Lower molecular weight cleaved polymer would have higher solubility. However, very high fluoride concentrations can lead to an attack on the oxide/metal interface. Therefore, optimizing the formulations presented in this patent involved careful control of fluoride concentration to achieve optimal cleanability without sacrificing etch selectivity. In this regard, we note that the role of corrosion inhibitors is critical. A competitive binding model between the fluoride and inhibitor to the metal surface can explain the reduction of selectivity observed at high fluoride concentrations.

At least two inhibitors are necessary to protect copper surfaces. As discussed, an optimal combination of benzo and triazole-based inhibitors required a relative concentration ratio between 2:1 and 5:1. Such a ratio could be due to the corrosion inhibitors' differential binding affinity to exposed copper crystallographic planes.

The formulation comprises the following: an organic base mixture, a fluoride component, fluoride salts and hydroxides, sulfate and phosphate salts, and copper organic corrosion inhibitors.

Where the organic base mixture further comprises two or more organic bases with non-limiting examples such as tetramethylammonium hydroxide, tetrabutylammonium hydroxide, and similar molecules with differing alkyl chain lengths. Various combinations thereof are incorporated into the formulation. The fluoride component comprises non-limiting examples such as hydrofluoric acid (HF), ammonium fluoride, ammonium bi-fluoride, and hexafluorosilisic acid. The fluoride salts and hydroxides comprise the following non-limiting examples: potassium fluoride, potassium hydroxide, and sodium fluoride. The sulfate and phosphate salts comprise a mixture of at least two salts with non-limiting examples such as nickel sulfate, zinc sulfate, magnesium sulfate, potassium phosphate, sodium phosphate, and alkali metal meta and pyrophosphates. The copper organic corrosion inhibitors comprise a mixture of at least two inhibitors, non-limiting examples such as mercaptobenzothiazole, benzotriazole, ethylbenzotriazole, carboxybenzotriazole, 2-Mercapto-1-methylimidazole, triazole, benzenethiol, heptanethiol.

The composition of the new formulation and process conditions are significantly different than the current state of the art. The new formulation can strip the TiN film at a much faster rate, at least 2×, with no impact on ILD materials or Cu over a wide range of temperatures from room temperature up to 80° C. A faster etch rate allowed for a shorter recipe time and reduced chemical consumption. Furthermore, it provides capacity and throughput improvements. Some typical performance data are presented in Tables 1 and 2, below.

In Table 1 MTN shows robust selectivity with respect to the Ti etch rate in relation to oxide or Cu etch rates (>1600). Long bath and shelf lives are also observed. Table 2 shows etch rate (ER) as a function of H₂O₂ volume (%) concentration (note the balance is made up with UPW) and temperature. MTN etch rate significantly increases with temperature, which, as mentioned before, allows short recipe times and increases the wafer processing throughput.

TABLE 1

| | | | H₂O₂ | |
|---|---|---|---|---|
| Conditions | Time | MTN | Concentration | Water |
| Bath life | Over 48 hours | — | — | — |
| Shelf life | Over two years | — | — | — |
| Ti ER (55° C.) | 240 A/minute | 7.5 | 54 | 38.5 |
| Cu ER | <1 | — | — | — |
| Silicon dioxide ER | 0.15 A/minute | — | — | — |

TABLE 2

| | Ti ER | Cu-ER | Oxide |
|---|---|---|---|
| Composition | (A/min) | (A/min) | ER(A/min) |
| Control | 160 | 4.5 | 0.4 |
| 7.5% MTN 54% H2O2 50 C. | 240 | <1 | 0.15 |
| 7.5% MTN 60% H2O2 50 C. | 260 | <1 | — |
| 7.5% MTN 60% H2O2 60 C. | 410 | <1 | — |
| 7.5% MTN 30% H2O2 60 C. | 325 | <1 | — |

The formulation suppressed the formation of residues, mainly composed of aluminum oxyfluoride residue, on aluminum bonding pads formed in a humid environment. These post-plasma etch residues are composed of polymeric species containing Al, O, F, C, and Ti. A slightly modified formulation containing HF removed the residue. Presumably, both Ti and Al species in the polymer backbone are cleaved, forming their respective fluorides, which are water-soluble. Removal of residue leaves aluminum exposed, immediately creating a thin, dense, protective native aluminum oxide layer. Unlike current solvent-based state-of-the-art formulations, the new formulation's uniqueness and superiority stem from its ability to robustly remove the TiN layer with no impact on ILD materials and copper.

### EXAMPLES

Examples 1 to 3 below provide non-limiting examples of bath compositions. Each example provides the embodiment and best mode for each bath. Example 1 provides the best mode for TiN and/or Ti etching in the presence of copper. Example 2 provides the best mode for etching in the presence of aluminum, and Example 3 provides the best mode for etching in the presence of tungsten.

### Example 1

TiN and/or Ti etching is done in the presence of copper, and the ILD is exposed. In a first embodiment, a formulation, MTN, consists of NH₄F, TMAH, and KOH in a range of concentrations of 0.1-40, 1-25, 0.1-20% w/v, with preferred concentrations of 0.6, 1.32, 0.24% w/v, respectively. These formulations were prepared in UPW and contained corrosion inhibitor concentrations of 1-100000 ppm of benzotriazole and triazole, with a preferred concentration of 130 ppm. Relative weight ratios of the two inhibitors varied from 5:1 to 1:1 with the preferred relative weight ratio of 3:1. Additionally, several peroxide stabilizers, such as K₃PO₄ and ZnSO₄ at 0.01 to 80000 ppm level (the preferred concentration is 0.44 ppm) are present to stabilize bath reaction mixture which contains H₂O₂.

Although the pH of the new formulation, MTN, is greater than 12, in practical application, the MTN is mixed with H₂O₂ (30% w/v) and UPW at various dilution ratios to lower the pH of the reaction mixture to 7.5-8 (with the preferred pH at 7.5). Lower bath pH reduces the ILD (Silicon dioxide-based dielectric) etch rate. H₂O₂ provides an oxidizing environment for the oxidation of TiN. A typical etch bath composition contains MTN formulation, peroxide, and water in volume ratios of 6-9:25-35:54-69, respectively, with a preferred volume ratio of 7.5:30:62.5 (% v/v). Examples of bath compositions and properties appear in Tables 1 and 2. Typical bath operational temperature can vary between 20-80°

### Example 2

Ti and or TiN etching done in the presence of aluminum, is a second embodiment of the post-dry etch residue cleanup with exposed SiN, TiN, Al, polyimide, and ILD. In this case, the bath pH range can vary between 7-12. The etch bath composition was 6-15:5-25:60-85 (by volume) of MTN and H₂O₂ (30%) and UPW, respectively, with a preferred pH of 9. As previously discussed, the composition range can be adjusted by changing the relative volume proportions of MTN, H₂O₂, and UPW. The inclusion of benzotriazole and triazole also conferred the formulation compatibility with copper. Corrosion inhibitors depressed the copper etch rate (<1 A/min). SiN, ILD, and Polyimide etch rates were lower than 10 A/min. Aluminum etch rates were 10-50 A/min. Typical bath temperature can be between 20-80° C. but more preferably at 50° C.

### Example 3

A third embodiment is the removal of Ti and or TiN etch residue with MTN with W and ILD exposed: W is readily oxidized and attacked in hydrogen peroxide, so replacing it from bath reaction mixtures was necessary. Since W is stable at a pH below 4, the basic MTN formulation was mixed with acidic HF components to achieve a pH between 2-5. The typical preparation involved a dilution of MTN in UPW in volume ratios between 1:20-1:5. The resulting solution was mixed with a dilute aqueous solution of 48% HF solution (typically 0.1-0.5 wt %), resulting in a pH between 2-5 with the preferred pH of 3. Note that high HF concentrations lead to significant etching of SiO₂/ILD, which is undesirable. Etch rates for TiN, W, and ILD were 30 A-80 A/min, 2 A/min., and 2-5 A/min, respectively, at a bath temperature of 50° C. The formulations described in examples 1-3 provide satisfactory etch/clean performance in a few minutes with a wide operational range of temperatures between 20-80° C.

Applicant(s) reserves the right to submit claims directed to combinations and subcombinations of the disclosed inventions that are believed to be novel and non-obvious. Inventions embodied in other combinations and sub-combinations of features, functions, elements, and properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

Definition: The following definition applies unless stated otherwise. “Ti-Hard Mask(s),” includes hard masks comprising titanium (Ti) and or titanium nitride (TiN) either separately or used together.

It is claimed:

1. A composition for removing Ti-Hard Masks, post dry etch organic and inorganic residues, and polymers comprising: high molecular weight organic bases, inorganic bases, fluoride components, sulfate and phosphate salts, organic corrosion inhibitors and an oxidizer; where the composition is formed by combining the former ingredients with water.

2. Where the high molecular weight organic bases of claim 1 further comprise: a hydrocarbon chain having a chain length of 1 to 8 carbon atoms.

3. Where the high molecular weight organic bases of claim 1 is: TMAH or tetrabutylammonium hydroxide.

4. Where the inorganic bases of claim 1 can be at least one of the following: KOH, NaOH, and NH₄OH.

5. Where the fluoride components of claim 1 comprise at least one of the following: hydrofluoric acid, ammonium fluoride, ammonium bifluoride, hexafluorosilisic acid, potassium fluoride, and sodium fluoride.

6. Where the sulfate and phosphate salts of claim 1 comprise a mixture of at least one of the following: nickel sulfate, zinc sulfate, magnesium sulfate, potassium phosphate, sodium phosphate, and alkali metal meta and pyrophosphates.

7. Where the organic corrosion inhibitors of claim 1 inhibit the corrosion of copper and comprise a mixture of at least one of the following: mercaptobenzothiazole, benzotriazole, ethylbenzotriazole, carboxybenzotriazole, 2-Mercapto-1-methylimidazole, triazole, benzenethiol, and heptanethiol.

8. Where the water of claim 1 is UPW, and the oxidizer of claim 1 is hydrogen peroxide.

9. A composition for removing Ti/TiN hard masks, post dry etch organic and inorganic residues, and polymers comprising: at least one of the following bases: TMAH, NaOH, and KOH, at least one of the following fluoride compounds: hydrofluoric acid, ammonium fluoride, ammonium bifluoride, hexafluorosilisic acid, potassium fluoride, and sodium fluoride; a mixture of least one of the following sulfate and phosphate salts: nickel sulfate, zinc sulfate, magnesium sulfate, potassium phosphate, sodium phosphate, and alkali metal meta and pyrophosphates; corrosion inhibitors, an oxidizer, and UPW, where the composition is formed by combining the former ingredients with UPW.

10. Where the organic corrosion inhibitors of claim 9 inhibit the corrosion of copper and comprise a mixture of at least two of the following: mercaptobenzothiazole, benzotriazole, ethylbenzotriazole, carboxybenzotriazole, 2-Mercapto-1-methylimidazole, triazole, benzenethiol, and heptanethiol and the oxidizer of claim 9 is hydrogen peroxide (H₂O₂).

11. A composition for removing Ti/TiN hard masks, post dry etch organic and inorganic residues, and polymers comprising: providing a copper surface with an ILD material exposed; at least one of the following bases: TMAH, NaOH, and KOH; benzotriazole and triazole as corrosion inhibitors; hydrogen peroxide, and K₃PO₄ and ZnSO₄ as peroxide stabilizers; and UPW, where the composition is formed by combining the ingredients with UPW.

12. The composition of claim 10, where the pH is 7.8 to 8 and the composition temperature is between 20 to 80° C.

13. A composition for removing TiN, SiN, and polyamide hard masks, comprising: providing an aluminum surface with an ILD material exposed; the composition of claim 11 where the composition pH is between 7-12, and the composition temperature is between 20 to 80° C.

14. A composition for removing Ti/TiN hard masks, post dry etch organic and inorganic residues, and polymers comprising: providing a tungsten surface with an ILD material exposed; the composition of claim 11 where the concentration of H₂O₂ is 0%; where the pH was adjusted to 2-5 with hydrofluoric acid; and the composition temperature is between 20 to 80° C.
